(19) United States
(12) Patent Application Publication
(10) Pub. No.: US 2008/0049760 A1
(43) Pub. Date: Feb. 28, 2008

(54) Oversubscription in broadband network

(76) Inventor: Gilles Bergeron, Montreal (CA)

Correspondence Address: HOLLAND & KNIGHT LLP, 10 ST. JAMES AVENUE, 11th Floor, BOSTON, MA, 02116-3889, US

(21) Appl. No.: 11/509,236

(22) Filed: Aug. 24, 2006

(51) Int. Cl. H04L 12/56

(52) U.S. Cl. 370/395.21

(57) ABSTRACT

Methods and apparatus, including computer program products, for oversubscription in a broadband network. A computer-implemented method includes enabling maximum over subscription ratio (MOSR) parameters as part of Quality of Service (QoS) parameters defining a service class, and determining a minimum amount of resources (MAR) value required to be allotted to a service connection belonging to the service class so that at time t a value of the MOSR parameters does not exceed limits configured for a specific resource type to provide a service associated with the service class.

### BACKGROUND

The present invention relates to data processing by digital computer, and more particularly to oversubscription in a broadband network.

Data traffic in a network is considered “bursty” in nature, where a burst can be considered a continuous transfer of data without interruption. However, not all network services burst at the same time, so bandwidth that is not used for a particular service flow can be reallocated for other services. During peaks of network traffic, the sum of peak throughputs to which service connections are entitled exceeds many times the available network resources, since packet switched networks are traditionally considered to be over subscribed. In this event, all service connections compete for available resources. These network resources can include bandwidth/data throughput, processing resources, shared memory/storage, and time resources measured in bytes, seconds, or bytes per second.

### SUMMARY

The present invention provides methods and apparatus, including computer program products, for oversubscription in a broadband network.

In one aspect, the invention features a computer-implemented method including, in a packet switched network, enabling maximum over subscription ratio (MOSR) parameters as part of Quality of Service (QoS) parameters defining a service class, and determining a minimum amount of resources (MAR) value required to be allotted to a service connection belonging to the service class so that at time t a value of the MOSR parameters does not exceed limits configured for a specific resource type to provide a service associated with the service class.

In embodiments, determining the MAR value can include determining PIR/MOSR, wherein PIR represents a Peak Information Rate. Determining the MAR value can include determining ((PIR−CIR)/MOSR_{BE})+CIR/MOSR_{CIR}), wherein PIR represents a Peak Information Rate, CIR represents a Committed Information Rate, MOSR_{BE} represents a Maximum Over Subscription Ratio for Best Effort bandwidth, and MOSR_{CIR} represents Maximum Over Subscription Ratio for the Committed bandwidth.

The method can include performing admission control each time a new connection is generated or instantiated and requires resources provisioned.

Admission control can limit a total number of connections such that a sum of all minimum amount of resources calculated for all connections for any grade of service (GoS) class admitted or instantiated at time t is lower or equal to a total amount of resources available (TAR) or a predefined configurable fraction threshold (Th) in the form of a total amount of resources available.

Connections causing a limit

$$\sum MAR \leq TAR or \sum MAR \leq WM \cdot TAR$$

to be exceeded can be rejected and not admitted.

Admission control can limit a total number of connections of a grade of service (GoS) class such that a sum of all minimum amount of resources calculated for all connections of the GoS class admitted or instantiated at time t is lower or equal to a total amount of resources available as configured for the GoS class (TARₘᵢ) or a predefined configurable percentage of a total amount of resources made available to the class.

Connections causing a limit

$$\sum MAR \leq {TAR}_{mi} or \sum MAR \leq WM \cdot {TAR}_{mi}$$

to be exceeded can be rejected and not admitted.

An indication can be reported if connection admission is rejected.

The invention can be implemented to realize one or more of the following advantages.

The method enables the creation of differentiated levels of service with respect to their access to resources not committed and the over subscription ratio experienced by the connections during busy/congested network conditions. An operator of a network can create differentiated classes of services using a Maximum Over Subscription Ratio (MOSR). MOSR control enables a limit to how many times a set of connections shares the same amount of resources based on their class.

An operator can generate different levels of best effort services defined by MOSR. When combined with MAR allocation involving a dynamic resources allocation mechanism, it provides minimum protection of the best effort service types from complete resources cannibalization from higher priority services such as multimedia and real time services. Admission control then ensures that all services classes received their required and fair amount of resources, taking into account service connections MARs.

The method ensures fairness between different levels of service provided at different pricing. These parameters, combined with the other configurable Quality of Service (QoS) parameters, enable better control of resources allocated to different end-users. This results in a better ability to meet traffic transport requirements of different applications. This enables support of Service Level Agreements (SLAs) with fair access to access network resources.

The method can be applied to the network resources involved in any one or more of the following: temporary storage/buffering, classification, queuing, scheduling and/or transport (reception, transmission) of data traffic exchanged over one or more network links including an air link.

The method can be applied to provide oversubscription limits to several types of network resources, including, for example, bandwidth/data throughput, processing resources, shared memory/storage, and time resources measured in bytes, seconds, or bytes per second.

The method can be applied to a downlink and uplink data traffic total bandwidth and other types of resources.

The method enables configuration of MOSR parameters in association with resource allocation QoS parameters in general, and more specifically, to service classes defined traffic rate, i.e., reserved data rates and maximum sustained rates provided in a best effort manner.

The method can be used as an admission control and resource allocation technique in any packet switching platform implementing differentiated grades of services (GoS) or quality of services (QoS) involving a mix of committed and best effort resource allocation. MOSR is a QoS-configurable parameter.

The MAR is used for overscription control. The oversubscription ratio control involves a reservation of the MAR from a pool of resources in association with a connection or flow.

The MAR is used by a dynamic resource allocation/control mechanism such that the amount of resources continuously granted to each connection is meeting, as a minimum, the respective MAR parameters of the connections.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary packet switched wireless access network.

FIG. 2 is a flow diagram of a network process.

FIG. 3 is a flow diagram of a network process.

Like reference numbers and designations in the various drawings indicate like elements.

### DETAILED DESCRIPTION

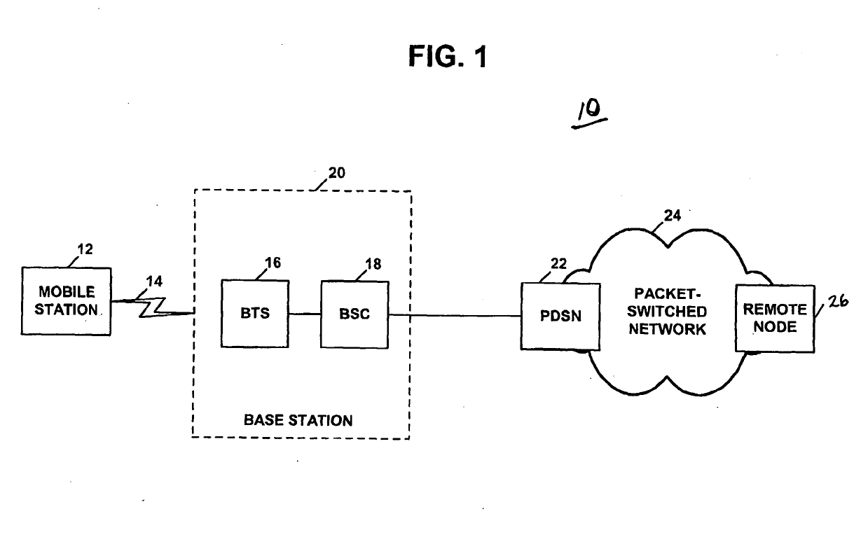

As shown in FIG. 1, an exemplary packet switched wireless access network 10 includes a mobile station (MS) 12 communicating over an air link 14 with a base transceiver station (BTS) 16 and in turn with a base station controller (BSC) 18. Here, the BTS 16 and BSC 18 cooperatively define a base station (BS) 20. The air link 14 is a radio-frequency portion of a circuit between the MS 12 and BS 20. BSC 18 is coupled by a link to a packet data serving node (PDSN) 22, which, as a network access server, provides connectivity with a packet switched network 24, such as the Internet. A remote node 26 may in turn sit on or be accessible via the packet-switched network 24.

The MS 12 can take various forms. For example, the MS 12 can be a mobile or portable multimedia wireless terminal including, for example, a cellular or personal communications services (PCS) telephone, a notebook computer or personal digital assistant (PDA) that includes or is connected with a cellular or PCS telephone or with a wireless communications card, and so forth.

End-to-end communication is established from the MS 12 to the remote node 26 over a packetized communication path including the air link 14 between the MS 12 and the BS 20, the link between the BS 20 and the PDSN 22, and the packet-switched network 24 between the PDSN 22 and the remote node 26.

Packet data services residing in the packet switched wireless access network (or over any packet switched network) 10 call for various levels of quality of service (QoS). Quality of Service (QoS) is a measure of network performance that reflects the packet switched wireless access network's 10 transmission quality and service availability. All service flows in the packet switched wireless access network 10 are characterized by a set of associated QoS parameters, such as latency, jitter, and throughput assurance. Jitter is the variation in time between packets arriving, caused by network congestion, timing drift, or route changes. Latency is an expression of how much time it takes for a packet of data to get from one designated point to another. These QoS parameters can be tailored on a per connection basis to best address the needs of different traffic types carried by service connections. Several connections can share the same set of QoS parameters.

A specific set of values for QoS parameters defines a Class of Service (CoS) or Grade of Service (GoS), where CoS is a way of managing traffic in the network 10 by grouping similar types of traffic (such as e-mail, streaming video, voice, large document file transfer, and so forth) together and treating each type as a class with its own level of service priority. GoS classes are defined in each BS 20. QoS parameters enable a traffic rate to be assigned to each service flow.

Maximum Sustained Traffic Rate is one parameter that defines a Peak Information Rate (PIR) of a service flow. The PIR is expressed in bits per second and the service flow traffic is policed to conform to this parameter and not to exceed, on the average, over time, this limit. The traffic rate for conformance purposes is estimated for any interval of time of one second or more. PIR does not specify a guarantee that the rate is available. The actual service traffic rate can be lower depending on a total number of services deployed and instant bandwidth utilization. The PIR is provided in a best effort manner. An aggregate PIR of all service flows typically exceeds the amount of available bandwidth in a sector.

Minimum Reserved Traffic Rate is a second parameter that defines a Committed Information Rate (CIR) and specifies a minimum rate reserved for a service flow. The CIR is expressed in bits per second and specifies a minimum amount of data to be transported over a service flow when averaged over a period of time of one second or more, for example. The traffic rate defined by Minimum Reserved Traffic Rate is guaranteed, i.e., BS 20 shall be able to satisfy bandwidth requests for a service flow up to its Minimum Reserved Traffic Rate.

While guaranteed, a CIR for a service flow does not mean that air link 14 bandwidth is dedicated to that service flow. If less bandwidth than its Minimum Reserved Traffic Rate is requested for a service flow, the BS 20 may reallocate the excess reserved bandwidth for other purposes. Therefore, an aggregate CIR of all service flows configured may also exceed the amount of available bandwidth over the air link 14. Reallocation ensures that the bandwidth guaranteed is available to the services with data to transfer.

A provision of a CIR for a service flow can improve the performance for those service flows less tolerant to delay. CIR grants a service flow with a minimum throughput. When required, guaranteed service flows (i.e., CIR=PIR) can be used to ensure minimum delay transfer and avoid congestion. This can be done in conjunction with a selection of a real time type service where delay is controlled.

Using these two parameters, i.e., Maximum Sustained Traffic Rate and Minimum Reserved Traffic Rate, all service flows are considered to fall into one of three categories. Those service flows falling under a “Best Effort Services” category only have a PIR (and then CIR=0). With these service flows, there is no minimum rate guaranteed; all the service flow bandwidth is provided in a best effort manner.

Those service flows falling under a “Better than Best Effort Services” category are service flows with a CIR greater than 0 and a PIR greater than CIR. These service flows have a portion of the traffic rate guaranteed as a minimum available and are eligible to additional bandwidth in excess of the CIR. The BS 20 provides the excess bandwidth in a best effort manner.

Those service flows falling under a “Guaranteed Services” (static or dynamic) category are the service flows for which CIR=PIR, e.g., an assigned data trunk (static) or a voice line (dynamic). As mentioned above, while guaranteed, the bandwidth allocated to these service flows is not dedicated.

Any service flow can be seen as including a guaranteed portion equal to CIR and a best effort portion equal to the difference between the PIR and CIR, i.e., PIR−CIR. When considering all the service flows provisioned over the air link 14, the aggregate CIR of all the service flows represents the total guaranteed bandwidth provisioned. In a similar way, the aggregate (PIR−CIR) of all the service flows represents the total best effort bandwidth provisioned.

As mentioned above, data traffic is bursty in nature and because all the service flows do not burst at the same time, the bandwidth that is not requested for a service flow can be reallocated for other service flows. This allows air link 14 utilization to be optimized.

In practice, the total best effort bandwidth and the total guaranteed bandwidth provisioned over a packet switched link can exceed the amount of available bandwidth in a sector over the air link 14. In general, the ratio of the aggregate service bandwidth provisioned to the available bandwidth, over a packet switched link, is called the over subscription ratio (OSR) and is defined as:

$$OSR = \frac{Total Information Rate Provisioned}{Available Bandwidth}$$

For any resource type R:

$${OSR}_{R} = \frac{Total Amount of Resources Provisioned}{Available Amount of Resources}$$

The higher the value of the OSR, the more times the available bandwidth is shared, the higher the probability of services bursting simultaneously. This limits the possibility for the air link 14 to grant each service flow with, for example, the configured Maximum or Peak Information Rate.

To better control the way the service bandwidth is allocated to the different service flows in the network 10, we enable a scheme for the configuration of two Maximum OSR parameters for each service class. These parameters are complementary QoS parameters. These maximum OSR parameters apply to a service class and therefore to all the service flows that are configured using that same service class.

A first OSR parameter is referred to as a Maximum Over Subscription Ratio for Best Effort (MOSR_{BE}) bandwidth of a service, i.e. PIR−CIR, and is defined as:

$${MOSR}_{BE} = \frac{PIR - CIR}{Available Bandwidth for Best Effort Service}$$

A second OSR parameter is referred to as Maximum Over Subscription Ratio for the Committed bandwidth (MOSR_{CIR}) and is defined as:

$$\frac{CIR}{Available Bandwidth for Oversubscription}$$

Our scheme uses these OSR parameters in two ways. First, the OSR parameters are used by the air link 14 or the packet switched network elements 24 to dynamically allocate to all service flows of a service class a fair share of the bandwidth, resources (for both the best effort portion and the guaranteed portion of the service). The OSR parameters ensure that the number of times the available bandwidth allocated to a QoS class is shared does not exceed the MOSR configured. The bandwidth granted to each service flow within a class is controlled by the MOSR.

Second, the OSR parameters are used by network 10 in an admission control process, along with other parameters, to protect the services and bandwidth. The admission control process provides a verification of the total number of provisioned connections and admitted connections, traffic rate and MOSR requirements defined by the QoS parameters assigned against the air link 14 resources required at the creation of each service flow. The available air link 14 resources are computed by keeping a record of the aggregate bandwidth of all the best effort portions and the guaranteed portions of the services, as defined above.

Admission control ensures that all the service classes get their fair share of the bandwidth as configured. Admission control also protects system resources from being over-allocated, which can result in the impossibility to meet the service class QoS configuration. Admission control is preformed prior to an admission of any service flow in both upstream and downstream directions. A service flow admission is rejected when the allocation of resources to the service flow results in the MOSR for the services classes to be exceeded and become uncontrolled.

Our scheme is applicable to a point-to-point or point-to-multipoint wireless or wired system, and more generally to any packet switching processing nodes, equipment devices or computer platforms used for concurrent wireless or wired switching and transmission of packet data payload, including but not limited to, IP, MPLS, VPN/Tunneling protocols, PPPoE, carrying management, control, signaling, voice, video, indirect traffic, emails, gaming traffic and/or multimedia traffic, including IP Multimedia Services data over N uplink data service channels/connection and O downlink data service channels/connections. Here, each of the N and O connections are associated with a specific set of QoS parameters governing the connection traffic rate, latency, jitter, prioritization and/or in general resource allocations and defining a class or grade of service within M classes of grade of service.

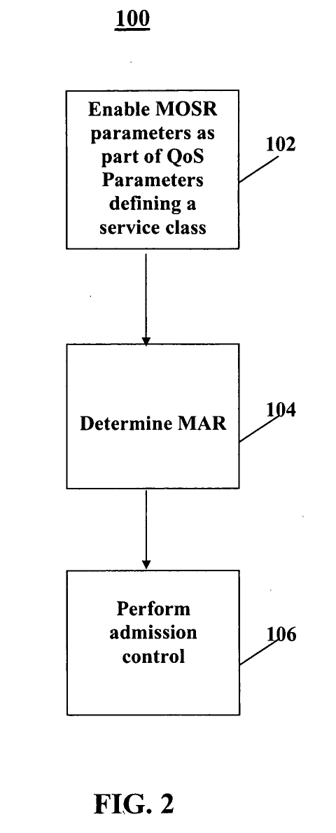

As shown in FIG. 2, a network process 100 includes enabling (102) maximum over subscription ratio (MOSR) parameters as part of Quality of Service (QoS) parameters defining a service class. Process 100 determines (104) a minimum amount of resources (MAR) value required to be allotted to a service connection belonging to the service class so that at time t a value of the MOSR parameters does not exceed limits configured for a specific resource type to provide a service associated with the service class.

In one example, determining (104) the MAR value can include determining PIR/MOSR, wherein PIR represents a Peak Information Rate. In another example, determining (104) the MAR value can include determining ((PIR−CIR)/MOSR_{BE})+CIR/MOSR_{CIR}), wherein PIR represents a Peak Information Rate, CIR represents a Committed Information Rate, MOSR_{BE} represents a Maximum Over Subscription Ratio for Best Effort bandwidth, and MOSR_{CIR} represents Maximum Over Subscription Ratio for the Committed bandwidth.

Process 100 includes performing (106) admission control each time a new connection is generated or instantiated and requires resources provisioned. In one example, admission control (106) can limit a total number of connections such that a sum of all minimum amount of resources calculated for all connections for any grade of service (GoS) class admitted or instantiated at time t is lower or equal to a total amount of resources available (TAR) or a predefined configurable threshold in the form of a fraction (Th) of a total amount of resources available. Connections causing a limit

$$\sum MAR \leq TAR or \sum MAR \leq WM \cdot TAR$$

to be exceeded are rejected and not admitted.

In another example, admission control (106) can limit a total number of connections of a grade of service (GoS) class such that a sum of all minimum amount of resources calculated for all connections of the GoS class admitted or instantiated at time t is lower or equal to a total amount of resources available as configured for the GoS class (TARₘᵢ) or a predefined configurable threshold expressed as a percentage of a total amount of resources (Th) made available to the class. Connections causing a limit

$$\sum MAR \leq {TAR}_{mi} or \sum MAR \leq WM \cdot {TAR}_{mi}$$

to be exceeded are rejected and not admitted.

An indication can be reported if connection admission can be rejected.

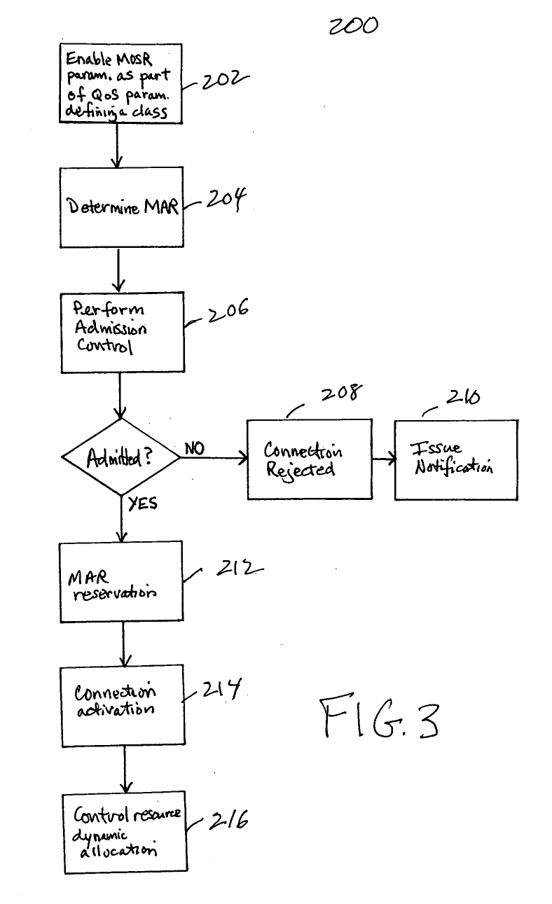

As shown in FIG. 3, a network process 200 includes enabling (202) MOSR parameters as part of QoS parameters defining a class. Process 200 determines (204) MAR and performs (206) admission control to determine whether the packet is admitted. If not admitted, process 200 rejects (208) admission and issues (210) a rejection notification. If admitted, process 200 performs (212) MAR reservation, activates (214) a connection, and controls (216) resource dynamic allocation to enforce MAR as a minimum to the correction.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
in a packet switched network, enabling maximum over subscription ratio (MOSR) parameters as part of Quality of Service (QoS) parameters defining a service class; and
determining a minimum amount of resources (MAR) value required to be allotted to a service connection belonging to the service class so that at time t a value of the MOSR parameters does not exceed limits configured for a specific resource type to provide a service associated with the service class.

2. The computer-implemented method of claim 1 wherein the MAR is used for oversubscription ratio control, the oversubscription ratio control a reservation of the MAR from a pool of resources in association with a connection or flow.

3. The computer implemented method of claim 1 wherein the MAR is used by a dynamic resource allocation/control process so that a number of resources continuously granted to each connection meets at a minimum respective MAR parameters of the connection.

4. The computer-implemented method of claim 1 wherein determining the MAR value comprises:
determining PIR/MOSR, wherein PIR represents a Peak Information Rate.

5. The computer-implemented method of claim 1 wherein determining the MAR value comprises:
determining ((PIR−CIR)/MOSR_{BE})+CIR/MOSR_{CIR}), wherein PIR represents a Peak Information Rate, CIR represents a Committed Information Rate, MOSR_{BE} represents a Maximum Over Subscription Ratio for Best Effort bandwidth, and MOSR_{CIR} represents Maximum Over Subscription Ratio for the Committed bandwidth.

6. The computer-implemented method of claim 1 further comprising:
performing admission control each time a new connection is generated or instantiated and requires resources provisioned.

7. The computer-implemented method of claim 6 wherein admission control limits a total number of connections such that a sum of all minimum amount of resources calculated for all connections for any grade of service (GoS) class admitted or instantiated at time t is lower or equal to a total amount of resources available (TAR) or a predefined configurable threshold in a form of a fraction of a total amount of resources available.

8. The computer-implemented method of claim 7 wherein connections causing a limit
$$\sum MAR \leq TAR or \sum MAR \leq WM \cdot TAR$$
to be exceeded are rejected and not admitted.

9. The computer-implemented method of claim 6 wherein admission control limits a total number of connections of a grade of service (GoS) class such that a sum of all minimum amount of resources calculated for all connections of the GoS class admitted or instantiated at time t is lower or equal to a total amount of resources available as configured for the GoS class (TARₘᵢ) or a predefined configurable percentage of a total amount of resources made available to the class.

10. The computer-implemented method of claim 9 wherein connections causing a limit
$$\sum MAR \leq {TAR}_{mi} or \sum MAR \leq WM \cdot {TAR}_{mi}$$
to be exceeded are rejected and not admitted.

11. The computer-implemented method of claim 10 wherein an indication is reported if connection admission is rejected.

12. A computer program product, tangibly embodied in an information carrier, for enabling oversubscription control in a packet switched network, the computer program product being operable to cause data processing apparatus to:
enable maximum over subscription ratio (MOSR) parameters as part of Quality of Service (QoS) parameters defining a service class; and
determine a minimum amount of resources (MAR) value required to be allotted to a service connection belonging to the service class so that at time t a value of the MOSR parameters does not exceed limits configured for a specific resource type to provide a service associated with the service class.

13. The computer program product of claim 12 wherein the MAR is used for oversubscription ratio control, the oversubscription ratio control comprising a reservation of the MAR from a pool of resources in association with a connection or flow.

14. The computer program product of claim 12 wherein the MAR is used by a dynamic resource allocation/control process so that a number of resources continuously granted to each connection meets a minimum respective MAR parameters of the connection.

15. The computer program product of claim 12 wherein determining the MAR value comprises:
determining PIR/MOSR, wherein PIR represents a Peak Information Rate.

16. The computer program product of claim 12 wherein determining the MAR value comprises:
determining ((PIR−CIR)/MOSR_{BE})+CIR/MOSR_{CIR}), wherein PIR represents a Peak Information Rate, CIR represents a Committed Information Rate, MOSR_{BE} represents a Maximum Over Subscription Ratio for Best Effort bandwidth, and MOSR_{CIR} represents Maximum Over Subscription Ratio for the Committed bandwidth.

17. The computer program product of claim 12 further operable to cause data processing apparatus to:
perform admission control each time a new connection is generated or instantiated and requires resources provisioned.

18. The computer program product of claim 17 wherein admission control limits a total number of connections such that a sum of all minimum amount of resources calculated for all connections for any grade of service (GoS) class admitted or instantiated at time t is lower or equal to a total amount of resources available (TAR) or a predefined configurable threshold expressed as a fraction of a total amount of resources available.

19. The computer program product of claim 18 wherein connections causing a limit
$$\sum MAR \leq TAR or \sum MAR \leq WM \cdot TAR$$
to be exceeded are rejected and not admitted.

20. The computer program product of claim 17 wherein admission control limits a total number of connections of a grade of service (GoS) class such that a sum of all minimum amount of resources calculated for all connections of the GoS class admitted or instantiated at time t is lower or equal to a total amount of resources available as configured for the GoS class (TARₘᵢ) or a predefined configurable percentage of a total amount of resources made available to the class.

21. The computer program product of claim 20 wherein connections causing a limit
$$\sum MAR \leq {TAR}_{mi} or \sum MAR \leq WM \cdot {TAR}_{mi}$$
to be exceeded are rejected and not admitted.

22. The computer program product of claim 21 wherein an indication is reported if connection admission is rejected.
